(19) United States
(12) Patent Application Publication
(10) Pub. No.: US 2009/0212237 A1
(43) Pub. Date: Aug. 27, 2009

(54) COMPOSITION FOR DETERMINATION OF IONIZING RADIATION ABSORBED DOSE AND USE THEREOF

(76) Inventors: Megumi Sugiki, Osaka (JP); Koji Iwase, Osaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/911,052

(22) PCT Filed: Apr. 7, 2006
(86) PCT No.: PCT/JP2006/307455

§ 371 Date: Dec. 3, 2008

(30) Foreign Application Priority Data
Apr. 8, 2005 (JP) 2005-112359

(51) Int. Cl. G01N 21/00

(52) U.S. Cl. 250/474.1

(57) ABSTRACT

For providing a composition for ionizing radiation determination that realizes determination of absorbed dose simply in enhanced quantitative manner while avoiding any influences from visible light, ultraviolet rays, etc. with the use of a composition for determination of ionizing radiation absorbed dose being highly responsive to ionizing radiation, there is provided a composition for determination of ionizing radiation absorbed dose containing a material capable of coloring or discoloring upon exposure to ionizing radiation, characterized by further containing zinc oxide.

### RELATED APPLICATION

This is a U.S. national phase application under 35 U.S.C. §371 of International Application No. PCT/JP2006/307455 filed Apr. 7, 2006, which claims priority of Japanese Patent Application No. 2005-112359 filed Apr. 8, 2005.

### TECHNICAL FIELD

The present invention relates to a composition for determination of ionizing radiation absorbed dose capable of being produced more easily and highly responsive to low exposure dose, further, capable of quantitatively indicating ionizing radiation absorbed dose as a change of color density, and to use thereof.

### BACKGROUND ART

In recent years, industrial applications of ionizing radiation such as electron beam and γ-ray have been covering various fields including sterilization of medical supplies, sterilization of blood products, preservation of food freshness, and crosslinking of plastics such as shrink tube.

In utilization of these ionizing radiation, there is no effect when absorbed dose is little, whereas when too large, it poses an economic disadvantage and material deterioration, the degree of absorbed dose of ionizing radiation greatly affects the effects obtained, so that it is important to determine the absorbed dose of ionizing radiation exposing an object substance. However, in sterilization of medical supplies of plastics where ionizing radiation is widely used, it is common to expose about 20000 to 30000 Gy of γ-ray from Co-60, whereas upon exposure to foods, about 100 to 1000 Gy of exposure for sterilization of parasite and bug, and 1000 to 10000 Gy of exposure for sterilization of microbe are adopted, optimal absorbed dose of ionizing radiation differs several hundred times in response to applications. Therefore, to determine precisely the absorbed dose of ionizing radiation exposed to an object substance, there must be used a composition for determination of ionizing radiation absorbed dose capable of responding sharply to a lower exposure dose, further, always reproducing quantitative measurements between variation widths of almost two figures in exposure dose.

Materials for measuring this absorbed dose of ionizing radiation have been known since long time ago, and as a typical one, there is disclosed a composition for determination of ionizing radiation absorbed dose using a composition comprising a certain leuco compound and a radical generator (organic halogen compound generating radicals upon exposure to ionizing radiation) (see, e.g., JP49-28449B). This kind of composition for determination of ionizing radiation absorbed dose can be detected in a low absorbed dose, but it is turned to the same color in response to visible lights or ultraviolet rays, hence there has been a problem that it is difficult to determine the absorbed dose of ionizing radiation quantitatively by existence or nonexistence of coloring and its degree.

To solve the problem, there have been made studies for being stable and not responsive to various irradiated radiations other than ionizing radiation and selectively responsive to only ionizing radiation. However, compositions for determination of ionizing radiation absorbed dose obtained from such studies have had a problem that they are generally responsive to only ionizing radiation with high absorbed dose, and irradiated radiation with low absorbed dose cannot be detected.

From this situation, there have been studying compositions for determination of ionizing radiation absorbed dose being not responsive to visible lights and ultraviolet rays, selectively responsive only to ionizing radiation and capable of detecting lower absorbed dose. Namely, there are disclosed a technique of changing into non-response to visible lights and ultraviolet rays by microcapsulation of a certain radiation responsive composition (see, e.g., JP2001-242249A); a technique that on a sheet-like substrate, a layer containing a composition for determination of ionizing radiation absorbed dose containing a color precursor capable of coloring by reaction with an acid and a compound generating an acid by ionizing radiation is formed, further a layer containing an ultraviolet shielding material is formed thereon (see, e.g., JP2002-156454A).

### DISCLOSURE OF INVENTION

In recent years, high performance compositions for determination of ionizing radiation absorbed dose have increasingly been required, however, in JP2001-242249A, there are problems that non-responsive property to visible lights or ultraviolet rays is not sufficient, and operations for producing microcapsules are tedious, in JP2002-156454A, there are problems that coloring occurs between a layer containing a composition for determination of ionizing radiation absorbed dose is formed on a sheet substrate and further a layer containing an ultraviolet shielding material is formed thereon in a production process, and the operation steps are many.

In this way, when trying to detect ionizing radiation from lower absorbed dose, a high responsive composition to ionizing radiation needs to be used, then the degree of influence of visible lights or ultraviolet rays also becomes high, thus, it is difficult to determine the absorbed dose of ionizing radiation correctly. Further, even if means for avoiding influence of visible lights or ultraviolet rays are devised, such various existing problems that the production of material for determination becomes tedious and effects to be expected are not obtained are left unsolved.

In this situation, it is an object of the present invention to provide a composition for determination of ionizing radiation absorbed dose capable of determining absorbed dose simply and quantitatively, by avoiding influences of visible lights, ultraviolet rays etc. while utilizing a composition for determination of ionizing radiation absorbed dose being highly responsive to ionizing radiation.

As a means for solving the above-described problems, first in order to produce a composition for determination simply, the present inventors have studied materials on a concept that there can be obtained a composition for determination capable of avoiding influence of visible lights and ultraviolet rays just by mixing directly with a material capable of coloring or discoloring by low absorbed dose of ionizing radiation, as a result, found the knowledge that although many ultraviolet absorbing materials are present, usable ones are few, of which zinc oxide is suitable for practical use. However, since zinc oxide, being an inorganic material, is opaque to result in the lowering of visibility, and generates a new problem that coloring and the degree of discoloring are difficult to determine. Hence, they have continued studying and found that this problem can be solved by using zinc oxide with a certain particle diameter or smaller, and completed the present invention.

Namely, the present invention provides a composition for determination of ionizing radiation absorbed dose and the applications.

(1) A composition for determination of ionizing radiation absorbed dose containing a material capable of coloring or discoloring by ionizing radiation, characterized by further containing zinc oxide.

(2) The composition for determination of ionizing radiation absorbed dose described in the paragraph (1), wherein said zinc oxide has an average particle diameter of at most 0.2 μm.

(3) The composition for determination of ionizing radiation absorbed dose described in the paragraph (1) or (2), wherein the material capable of coloring or discoloring by ionizing radiation contains at least one member selected from the group consisting of (A) a combination of a color indicative electron-donating organic compound and an organic compound showing an electron-accepting property by ionizing radiation, and (B) at least one dye selected from the group consisting of dyes capable of coloring through decomposition upon exposure to ionizing radiation.

(4) The composition for determination of ionizing radiation absorbed dose described in any one of the paragraphs (1) to (3), wherein the content of said zinc oxide is 1 to 50% by mass based on the total amount of the composition for determination of ionizing radiation absorbed dose.

(5) A sheet for determination of ionizing radiation absorbed dose, wherein a layer formed from the composition for determination of ionizing radiation absorbed dose described in any one of the paragraphs (1) to (4) is formed on at least part of a substrate.

(6) The sheet for determination of ionizing radiation absorbed dose described in the paragraph (5), wherein at least one other layer is formed between a substrate and a layer formed from the composition for determination of ionizing radiation absorbed dose.

(7) The sheet for determination of ionizing radiation absorbed dose described in paragraph (5) or (6), wherein at least one other layer is formed on the surface of said layer formed from the composition for determination of ionizing radiation absorbed dose at an opposite side to the substrate.

(8) The sheet for determination of ionizing radiation absorbed dose described in any one of the paragraphs (5) to (7), wherein at least one layer present on one side or both sides of said layer formed from the composition for determination of ionizing radiation absorbed dose has a gas barrier function.

(9) A container for determination of ionizing radiation absorbed dose, where a layer formed from the composition for determination of ionizing radiation absorbed dose described in any one of the paragraphs (1) to (4) is formed at least partly.

(10) The container for determination of ionizing radiation absorbed dose described in the paragraph (9), wherein at least a part of the container has a region laminated with at least 3 layers, and said layer formed from the composition for determination of ionizing radiation absorbed dose constitutes an intermediate layer of said region

(11) The container for determination of ionizing radiation absorbed dose described in the paragraph (10), wherein at least one layer of at least one side layer sandwiching the layer formed from the composition for determination of ionizing radiation absorbed dose has a gas barrier function.

### BEST MODE FOR CARRYING OUT THE INVENTION

The present invention will be described in detail below.

The composition for determination of ionizing radiation absorbed dose of the present invention contains zinc oxide in addition to a material capable of coloring or discoloring by ionizing radiation to avoid the influence of visible lights and ultraviolet rays on coloring or discoloring of said material. In general, in addition to these materials, it further contains a binder resin, and these materials are used in a coating agent state under dispersing/dissolving in a solvent.

In the present invention, ionizing radiation means radiation giving an ionization effect to a irradiated substance, including X-ray, α-ray, β-ray (electron ray), and γ-ray. Ultraviolet ray with short wavelengths are sometimes included in ionizing radiation, but ultraviolet rays are not included in ionizing radiation in the present invention because the present invention aims to determine accurately the absorbed dose of other ionizing radiations eliminating the influence of ultraviolet rays.

(1) Concerning with Constituent materials of the composition for determination of ionizing radiation absorbed dose, the constituent materials of the composition for determination of ionizing radiation absorbed dose of the present invention are described below.
(1-1) Zinc oxide

Regarding zinc oxide, when an average particle diameter of zinc oxide is large, a membrane of a composition itself is opaque, visibility of color or discoloring is lowered, an average particle diameter of at most 0.2 μm is preferably adopted, and an average particle diameter of at most 0.1 μm is more preferable.

Additionally, as zinc oxide, there is a type coated with other materials on its surface for the reason of improvement in dispersibility and corrosion resistance. However, in the materials capable of coloring or discoloring by ionizing radiation, there are some materials undergoing coloring or discoloring by pH change etc., and thus, it is preferable to use zinc oxide not causing coloring or discoloring. For example, as the materials capable of coloring or discoloring by ionizing radiation, in the case where a material undergoing coloring or discoloring when pH is acid is used, zinc oxide not treated with acid materials is preferably used, on the other hand, in the case where a material undergoing coloring or discoloring when pH is basic is used, a zinc oxide covered/treated with acid or neutral materials is preferably used because zinc oxide is fundamentally basic.

The content of zinc oxide in the composition for determination of ionizing radiation absorbed dose is preferably 1 to 50% by mass based on the total amount of the composition, more preferably 1 to 40% by mass. Here, the total amount of the composition means the total amount of zinc oxide, the material capable of coloring or discoloring by ionizing radiation containing (A) [a combination of a color indicative electron-donating organic compound and an organic compound showing an electron-accepting property by ionizing radiation, and/or (B) a dye capable of coloring through decomposition upon exposure to ionizing radiation] and a binder (hereinafter the same meaning adopted). When the content of zinc oxide is less than the above-described range, the ultraviolet shielding effect is poor, whereas when more than the above-described range, the visibility of coloring or discoloring of the composition for determination of ionizing radiation absorbed dose tends to be lowered.

(1-2) Material capable of coloring or discoloring by ionizing radiation

As the material capable of coloring or discoloring by ionizing radiation in the present invention, it is not particularly limited and, any one used conventionally in such kind of composition for determination of ionizing radiation absorbed dose can be used. For example, there can be listed (A) a combination of a color indicative electron-donating organic compound and an organic compound showing an electron-accepting property by ionizing radiation, and (B) a dye capable of coloring through decomposition upon exposure to ionizing radiation.

(1-2-1) Material capable of coloring or discoloring by ionizing radiation of the above-described combination (A)

As the color indicative electron-donating organic compound, for example, without limitation in particular, there can be used various kinds of leuco dyes conventionally known as dyes for pressure sensitive copying papers or thermosensitive copying papers, and various leuco dyes known as other various kinds of dye precursors.

As specific examples of the color indicative electron-donating organic compound, there are listed triphenylmethanes or triarylmethanes such as triarylmethanes including leuco crystal violet, leucomarachite green, bis(4-diethylamino-2-methylphenyl)phenylmethane, and tris (4-diethylamino-2-methylphenyl)methane; triphenylphthalides such as leuco crystal violet lactone and leucomarachite green lactone; fluoranes such as 3-diethylamino-7-chlorofluorane, 3-diethylaminobenzo-α-fluorane, and 3-diethylamino -7-dibenzylaminofluorane and 3,6-dimethoxyfluorane; phenothiazines such as 3,7-bisdimethylamino-10-(4′-aminobenzoyl)phenothiazine, p-nitrobenzyl leuco methylene blue and benzoyl leuco methylene blue; indolylphthalides such as 3,3-bis(l-ethyl-2-methylindole-3-yl)phthalide and 3,3-bis(1-n-butyl-2-methylindole-3-yl)phthalide; leucoauramines such as N-(2,3-dichlorophenyl)leucoauramine and N-phenylleucoauramine; rhodamine lactones such as rhodamine B lactone; rhodamine lactams such as rhodamine B-o-chloroaminolactam, rhodamine B anilinolactam, and rhodamine B-p-chloroanilinolactam; indolines such as 2-(phenyliminoethanezylidene)-3,3′-dimethylindoline; diphenylmethanes such as 4,4-bis(dimethylaminophenyl)benzhydryl benzyl ether, N-halopheylleucoauramine and N-2,4,5-trichlorophenylleucoauramine; naphthopyrans such as 3-methylspirodinaphthopyran, 3-ethylspirodinaphthopyran, 3,3-dichlorospirodinaphthopyran and 3-benzylspirodinaphthopyran; Spiro compounds such as 3-propylspirobenzopyran, 3,6-bis(dimethylamino)fluorine-9-spiro-3′-(6′-dimethylaminophthalide), and 3-diethylamino-6-dimethylaminofluorene-9-spiro-3′-(6′-dimethylamino phthalide); azaphthalides such as 3-indolyl-3-aminophenylazaphthalide; and chromenoindole, phenazines such as aminodihydrophenazine; triazenes; naphtholactams; diacetylenes; and azomethines. These color indicative electron-donating organic compounds can be used alone or in combination of at least 2 kinds thereof.

As an organic compound showing an electron-accepting property by ionizing radiation used in a combination with the above-described color indicative electron-donating organic compound, any one of these so far known can be used generally without being particularly limited, and it is preferable to use an organic compound which tends to have electron-accepting properties by ionizing radiation.

The preferable example is an organic halogen compound, and there can be listed chlorides, bromide, fluorides and iodides with various low and high molecular weights.

As the organic halogen compound with a low molecular weight, one in liquid or solid at room temperature is used, and, for example, there are listed carbon tetrachloride, tetrabromoethane, chloroform, bromoform, dichloromethane, dibromomethane, 1,1,2,2-tetrachloroethane, 1,1,2-trichloroethane, 1,2,3-trichloopropane, 1,2,3-tribromopropane, 1,1,1-trichloroethane, 1,3-dibromobutane, 1,4-dibromobutane, 1,2-dichloroethane, n-octyl chloride, isopropyl bromide, perchlene (tetrachloroethylene), trichlene (trichloroethylene). 1,2,3,4-tetrachlorobenzene, 1,2,4,5-tetrachlorobenzene, 1,2,3-trichlorobenzene, 1,2,4-trichlorobenzene, o-dichlorobenzene, o-dibromobenzene, p-dichlorobenzene, p-dibromobenzene, monochlorobenzene, monobromobenzene, monoiodobenzene, trichloroacetic acid, ethyl α-bromobutyrate, phenyltrifluoromethane, 1,1,3-trihydrotetrafluoropronanol, 4,4′-dichlorodiphenyl-2,2-propane, o-chloroaniline, p-chloroacetophenone, o-chlorobenzoic acid, 3,4-dichlorotoluene, o-chloronitrobenzene, p-chlorobenzotrichloride, benzotrifluoride, 3,3′-dichloro-4,4′-diaminodiphenylmethane, N-bromosuccinimide, α,α,α-tribromomethylphenylsulfone, and 2′,2′-bis(2-chlorophenyl)-4,4′,5,5′-tetraphenyl-1,1′-bi-1H-imidazole. As the organic halogen compound in liquid at room temperature, low volatile one is preferable from the point that a stable composition ratio can be maintained in use of the composition for determination of ionizing radiation absorbed dose. For example, one with a boiling point of at least 40° C. at ambient pressure is preferred.

As the organic halogen compound with a high molecular weight, there are listed chlorinated polyethylene, chlorinated polypropylene, polyvinylchloride, polyvinylidenechloride, chlorinated rubber, hydrochlorinated rubber and chloroprene.

The above-described organic halogen compounds can be used alone or in combination of at least 2 kinds thereof.

The content of the color indicative electron-donating organic compound is preferably 0.05 to 40% by mass based on the total amount of the composition, more preferably 0.1 to 20% by mass. When the content of the color indicative electron-donating organic compound is less than the above-described range, visibility of coloring or discoloring tends to be not good. When the content of the color indicative electron-donating organic compound is more than the above-described range, suppression of coloring or discoloring by ultraviolet rays or visible lights becomes insufficient, or stepwise coloring or discoloring tends to become difficult to observe. The content of an organic compound showing an electron-accepting property by ionizing radiation is preferably 1 to 98.95% by mass based on the total amount of the composition, more preferably 3 to 75% by mass. When the content of the organic compound showing an electron-accepting property by ionizing radiation is less than the above-described range, visibility of coloring or discoloring tends to be not good. When the content of the organic compound showing an electron-accepting property by ionizing radiation is more than the above-described range, suppression of coloring or discoloring by ultraviolet rays or visible lights tends to become insufficient. Additionally, the kinds and composition ratios of both the color indicative electron-donating organic compound and organic compound showing an electron-accepting property by ionizing radiation can be optionally selected according to the kind and dose level of ionizing radiation to a detection object.

(1-2-2) Material (B) capable of coloring or discoloring by ionizing radiation of the above-described dye (B)

As a dye capable of coloring through decomposition upon exposure to ionizing radiation, among the above-described color indicative electron-donating organic compounds, there can be exemplified leuco dyes: triphenylmethanes or triarylmethanes such as leuco crystal violet, leucomalachite green, bis(4-diethylamino-2-methylphenyl)phenylmethane, and tris (4-diethylamino-2-methylphenyl)methane; triphenylphthalides such as leuco crystal violet lactone and leucomarachite green lactone; fluoranes such as 3-diethylamino-7-chlorofluorane, 3-diethylaminobenzo-α-fluorane, 3-diethylamino-7-dibenzylaminofluorane and 3,6-dimethoxyfluorane; phenothizines such as 3,7-bisdimethylamino-10-(4′-aminobenzoyl)phenothiazine, p-nitrobenzyl leuco methylene blue and benzoyl leuco methylene blue; indolylphthalides such as 3,3-bis(1-ethyl-2-methylindole-3-yl)phthalide and 3,3-bis(1-n-butyl-2-methylindole-3-yl)phthalide; leucoauramines such as N-(2,3-dichlorophenyl)leucoauramine and N-phenylleucoauramine; rhodamine lactones such as rhodamine B lactone; rhodamine lactams such as rhodamine B-o-chloroaminolactam, rhodamine B anilinolactam, and rhodamine B-p-chloroanilinolactam; indolines such as 2-(phenyliminoethanezylidene)-3,3′-dimethylindoline; diphenylmethanes such as 4,4-bis(dimethylaminophenyl)benzhydryl benzyl ether, N-halopheylleucoauramine and N-2,4,5-trichlorophenylleucoauramine. These dyes capable of coloring through decomposition upon exposure to ionizing radiation can be used alone, or in combination of 2 at least kinds thereof. The above-described dye capable of coloring through decomposition upon exposure to ionizing radiation is capable of coloring through decomposition upon exposure to ionizing radiation even in the presence of an organic compound showing an electron-accepting property by ionizing radiation (organic halogen compound). Here, the decomposition of a dye capable of coloring through decomposition upon exposure to ionizing radiation means that, for example, a hydrogen atom bonded to a tertiary carbon of the center of leuco dye compound such as triphenylmethanes or triarylmethanes is removed, or a lactone ring or a lactam ring in rhodamine lactams is cleaved to result in a coloring type structure of dye.

The content of the dye capable of coloring through decomposition upon exposure to ionizing radiation is preferably 0.05 to 40% by mass based on the total amount of the composition, more preferably 0.1 to 20% by mass. When the content of the dye capable of coloring through decomposition upon exposure to ionizing radiation is less than the above-described range, visibility of coloring or discoloring tends to be not good. When the content of the dye capable of coloring through decomposition upon exposure to ionizing radiation is more than the above-described range, suppression of coloring or discoloring by ultraviolet rays or visible lights becomes insufficient, or stepwise coloring or discoloring tends to become difficult to observe.

(1-3) Binder resin and solvent

As the binder resin usable in the present invention, it can be used without problems particularly, above all, a transparent one is preferred, as long as the presence of binder resin does not affect a material capable of coloring or discoloring by ionizing radiation (herein, “not affect” means that it does not excite or accelerate coloring or discoloring of said material in non-exposure to ionizing radiation, or it does not disturb coloring or discoloring of said material upon exposure to ionizing radiation, hereinafter the same), it has compatibility with a material capable of coloring or discoloring by ionizing radiation, and can be dissolved in the following suitable solvent to carry out printing and coating.

As the binder resin not affecting a material capable of coloring or discoloring by ionizing radiation, for example, in the case where a material undergoing coloring or discoloring when pH is acidic is used as described above, it is preferable to use a binder with no acid functional group, in the case where a material undergoing coloring or discoloring when pH is basic is used, it is preferable to use a binder with no basic functional group. Further, in the materials capable of coloring or discoloring by ionizing radiation, there is a material undergoing coloring or discoloring by a compound having an unsaturated bond, and when such compound is used, it is preferable to use a binder resin with a small iodine number, specifically at most 30.

As concrete examples of the binder resin, there are listed polystyrene, styrene/acrylate copolymer, styrene/methacrylate copolymer, polyacrylates such as polymethylacrylate and polyethylacrylate; polymethacrylates such as polymethylmethacrylate and polyethylmethacrylate; polyvinyl acetate, ethylene/vinyl acetate copolymer, polyurethane, bisphenol A (or, tetrabromobisphenol A, bisphenol F, bisphenol S etc.) type epoxy resins, novolac type epoxy resins, hydrocarbon resins, polyvinyl butyral, polyvinyl formal, polyamide resins, polyester resins and alkyd resins. These binder resins can be used alone or in a mixture of at least 2 kinds thereof.

The content of the binder resin in the composition is preferably 0 to 97.95% by mass, more preferably 5 to 97.95% by mass. The content of the binder resin can be suitably chosen within these ranges according to the kinds or the amount used of materials constituting the above-described composition for determination of ionizing radiation absorbed dose, a printing method or coating method.

Solvents usable in the present invention are not particularly limited and include, for example, alcohol solvents such as ethanol, butanol and propanol; ketone solvents such as methyl ethyl ketone, methyl isobutyl ketone, cyclohexanone and cyclopentanone; acetate solvents such as ethyl acetate, butyl acetate and amyl acetate (or, isoamyl); lactate solvents such as methyl lactate and ethyl lactate; glycol derivative solvents such as ethylene glycol monomethyl ether, ethylene glycol monoethyl ether, ethylene glycol monobutyl ether, 2-methoxyethyl acetate, ethylene glycol monoethyl acetate, propylene glycol monomethyl ether acetate, and propylene glycol monomethyl ether; aromatic solvents such as toluene and xylene; N,N-dimethylformamide, N,N-dimethylacetamide, dimethylsulfoxide, and diglyme. These solvents can be used alone or in a mixture of at least 2 kinds thereof.

(1-4) Other components

In the composition for determination of ionizing radiation absorbed dose of the present invention, further according to need, additives can be used such as a surfactant, a dispersing agent, a leveling agent, an antistatic agent, an antihalation agent and an antioxidant. Additionally, it is preferable to choose and use these additives suitably so that a material capable of coloring or discoloring by ionizing radiation is not affected, taking pH into consideration for example.

(2) Production method of the composition for determination of ionizing radiation absorbed dose of the present invention

The production method of the composition for determination of ionizing radiation absorbed dose of the present invention is not particularly limited as long as it can definitely obtain a target composition.

For example, first, in the presence of a binder resin and/or a dispersing agent, zinc oxide is dispersed in a solvent, for example, by a ball mill, atoriter, sand mill, three-roll mill and paint shaker.

Next, to a solution where zinc oxide is dispersed, added is a solution that (A) a color indicative electron-donating organic compound and an organic compound showing an electron-accepting property by ionizing radiation are solved, or two kinds of solutions that a color indicative electron-donating organic compound and an organic compound showing an electron-accepting property by ionizing radiation are each solved in a separate solvent, or a solution of (B) dye capable of coloring or discoloring through decomposition upon exposure to ionizing radiation, and stirred and mixed.

Further according to need, a solution that a binder resin was solved in a solvent is added so as to be a predetermined amount of binder resin, further according to need, a levering agent, a antistatic agent, an antihalation agent, an antioxidant etc. are added thereto, stirred and mixed, thereby to give a composition for determination of ionizing radiation absorbed dose of the present invention.

The composition for determination of ionizing radiation absorbed dose of the present invention can be used as coating solution in a form of printing ink (screen printing ink, gravure printing ink, offset printing ink, ink jet printing etc.) and paint.

(3) Application of the composition for determination of ionizing radiation absorbed dose

In the present invention, (3-1) a layer of the composition for determination of ionizing radiation absorbed dose (hereinafter also referred to as absorbed dose determination layer) is formed on at least part of a substrate, which is used as a sheet for determination of ionizing radiation absorbed dose. Alternatively, (3-2) an absorbed dose determination layer is formed in at least part of a container, which is used as a container for determination of ionizing radiation absorbed dose. Here, the container is a container for accommodating medical supplies, blood products, foods and plastic materials for crosslinking being subjected to exposure of ionizing radiation.

(3-1) Sheet for determination of ionizing radiation absorbed dose

The sheet for determination of ionizing radiation absorbed dose is a sheet-like region that an absorbed dose determination layer is formed on a substrate for determining the absorbed dose of ionizing radiation.

First, as a substrate for forming an absorbed dose determination layer, there can be exemplified a sheet-like substrate constituted by one kind or, at least 2 kinds of composite of materials such as plastic, synthetic paper, coated paper, paper, non-woven fabric, woven fabric, glass, metal foil and metal.

Additionally, it is preferable to use a substrate not affecting a material capable of coloring or discoloring by ionizing radiation, taking pH on the surface of the substrate into consideration for example.

By using a printing method such as silk screen printing, gravure printing, offset printing and ink jet printing, or a coating method by a coater such as a roll coater, spin coater and gravure coater, the composition for determination of ionizing radiation absorbed dose is printed or coated on a part of one surface or all surfaces of the above-described substrate so as to obtain a predetermined thickness of dry membrane, and dried to form an absorbed dose determination layer, and a sheet for determination of ionizing radiation absorbed dose can be obtained thereby.

Further, in the above-described constituent sheet for determination of ionizing radiation absorbed dose, at least one other layer may be provided on the surface of the absorbed dose determination layer at an opposite side of the substrate, and/or at least one other layer may be provided between the substrate and the absorbed dose determination layer. As the method for forming these other layers, when at least one other layer is provided on the surface of the absorbed dose determination layer at an opposite side of the substrate, a method of lamination of a suitable film or sheet and a method of application of a coating agent are listed, when at least one other layer is provided between the substrate and the absorbed dose determination layer, a method of lamination of a suitable film or sheet, a method of application of a coating agent and a method of evaporation coating of alumina or silica onto a substrate are listed.

As the above-described film or sheet, a film or sheet consisting mainly of polypropylene, polyethylene, nylon or polystyrene can be used. As the coating agent, there is listed one consisting mainly of a polyester resin, alkyd resin, polyurethane, acrylic resin, ethylene-vinyl acetate copolymer resin, vinyl chloride resin or vinylidene chloride resin.

As the layer formed on at least one side of the absorbed dose determination layer (including a substrate), at least one layer having a function enhancing added values is preferred. For example, it is more preferable to have a gas barrier function suppressing the permeation of oxygen or water vapor, and an ultraviolet shielding function. Additionally, in such layers, it is preferable to use one not affecting a material capable of coloring or discoloring by ionizing radiation, taking pH into consideration for example.

As the method for providing a gas barrier function, there can be used a method that a film deposited with alumina or silica is utilized as a substrate film or other layer; and a method of providing a gas barrier layer containing an inorganic lamellar compound such as montmorillonite and a high crystalline resin such as polyvinyl alcohol and saponified ethylene-vinyl acetate copolymer.

The material with a gas barrier function has also a function preventing components contained in a composition for determination of ionizing radiation absorbed dose from migration.

Ultraviolet shielding function as a function enhancing the above-described added values will be explained below, according to need (e.g., in the case of use in an environment exposed by fluorescent light or outdoor light for a long time), to suppress coloring or discoloring by ultraviolet rays of a material capable of coloring or discoloring by ionizing radiation, separately, an ultraviolet shielding layer may be provided on one surface or both surfaces of the layer of the composition for determination of ionizing radiation absorbed dose.

As a method for providing such ultraviolet shielding layer, there are listed a method of lamination of a film or sheet containing at least one kind selected from the group consisting of an organic ultraviolet absorber such as benzophenone, benzotriazole, benzoate and cyanoacrylate and an inorganic ultraviolet absorber such as metal oxide; and a method of applying a coating agent containing the above-described ultraviolet absorber.

The sheet for determination of ionizing radiation absorbed dose thus obtained is used by being pasted on goods to be subjected to exposure of ionizing radiation using a sticker or adhesive for example.

(3-2) Container for determination of ionizing radiation absorbed dose

The container for determination of ionizing radiation absorbed dose is a container for accommodating medical supplies, blood products, foods, and plastic materials for crosslinking being subjected to exposure of ionizing radiation, and for determining the absorbed dose of the ionizing radiation irradiated. The shape of a container includes box-like, bottle-like, tube-like, and bag-like one.

First, as a material for forming the container, there can be exemplified the same one as the material listed as a substrate of the aforementioned sheet. Further, as a method for forming an absorbed dose determination layer onto at least part of the container, there are listed (a) the aforementioned sheet for determination of ionizing radiation absorbed dose is pasted on at least part of the container, for example, using a sticker or adhesive; (b) an absorbed dose determination layer is formed on at least part of the container by using the same method as the case where the aforementioned sheet for determination of ionizing radiation absorbed dose is produced; (c) a region laminated with at least 3 layers is provided on at least part of the container, a layer formed from the composition for determination of ionizing radiation absorbed dose constitutes an intermediate layer of said region. In both the (a) method and (b) method, as a place providing a sheet for determination of ionizing radiation absorbed dose or an absorbed dose determination layer, it may be an outer surface or inner surface of a container. In the (c) method, it is no problem that an absorbed dose determination layer is an intermediate layer as long as it is visible. Herein, an intermediate layer means that it has at least one other layer on its both surfaces.

In the case where the absorbed dose determination layer in the (c) method is formed as an intermediate layer of the material forming a container, a lot of advantages are thought. For example, even if there are rubbed surface and deformation in a container, since the absorbed dose determination layer is not peeled from the container, it becomes possible for persons in medical institution to surely confirm where medical supplies or medicines are exposed by ionizing radiation or not. It is also excellent from the aspect of good hygiene because human skins and contents accommodated in a container do not directly contact an absorbed dose determination layer.

Regarding a method of forming an absorbed dose determination layer as an intermediate layer of the material forming such container, upon exposure to ionizing radiation, in the state where the absorbed dose determination layer is formed in the intermediate layer of the material forming the container, any method will be adopted. For example, there can be exemplified a method that an absorbed dose determination layer is formed on the surface of an article which has been shaped in container-like, further at least one other layer is formed thereon (thought to be one kind of the (b) method), or a method that an absorbed dose determination layer is formed on a film-like or sheet-like substrate, a lamination material that at least one other layer further formed thereon is processed into a container-shape. Additionally, in the latter method, if the state before processing into a container-shape is sheet-like, it corresponds to a sheet for determination of ionizing radiation absorbed dose, after processing, it corresponds to a container for determination of ionizing radiation absorbed dose.

On the other hand, as a layer formed on at least one side of an absorbed dose determination layer, it is preferable that the layer has at least one function necessary for a container and enhancing added values. For example, in addition to the above-described peeling preventing or hygienic function, it is preferable to have a barrier function suppressing permeation of oxygen and water vapor, and an ultraviolet shielding function. Further, when it is inside a container, it is preferable to have a function that prevents components contained in a composition for determination of ionizing radiation absorbed dose from migrating into a container, further, when a container is a bag, it is preferable to have a function capable of melt-sealing an edge easily to carry out bag forming easily.

Additionally, in such layers, it is preferable to use one not affecting a material capable of coloring or discoloring by ionizing radiation, taking pH into consideration for example.

Further, a bag-like container for determination of ionizing radiation absorbed dose formed from a material having a region laminated with at least 3 layers will be described in detail as an example.

First, the most fundamental constitution is a plastic packaging bag obtained by using a laminated material (lamination material) that three layers of a substrate, an absorbed dose determination layer and an melt-sealing layer are laminated.

As the substrate, for example, there can be used a film or sheet made of polypropylene, polyethylene, nylon, or polystyrene.

Further, as a material for forming the melt-sealing layer, there can be used polymers capable of conversion into a thin membrane by melting and lamination, such as low-density polyethylene, ethylene-vinyl acetate copolymer and polypropylene, in addition to a film-like material of unstretched polyethylene film or polypropylene film.

Then, after an absorbed dose determination layer is formed on a substrate by using the above-described method, when a melt-sealing layer is a film, it is pasted on the surface of the absorbed dose determination layer formed using an adhesive to produce a lamination material. On the other hand, when a melt-sealing layer is a meltable polymer, a melt polymer is extruded on the surface of the absorbed dose determination layer formed to adhere in a thin membrane state to produce a lamination material.

A target container for determination of ionizing radiation absorbed dose is obtained by matching the surfaces of melt-sealing layer of the lamination material thus obtained and melt-sealing the edge.

Further, as a method for providing a gas barrier function to enhance the added value of a container, there can be used a method that a film deposited with alumina or silica is utilized as a substrate film or film of melt-sealing layer, and a method of providing a gas barrier layer containing an inorganic lamellar compound such as montmorillonite and a high crystalline resin such as polyvinyl alcohol and saponified ethylene-vinyl acetate copolymer.

Further, the material with a gas barrier function has also a function that prevents components contained in a composition for determination of ionizing radiation absorbed dose from migration. Hence, when a melt-sealing layer itself is provided with a gas barrier function, or a material with a gas barrier function is provided between a melt-sealing layer and an absorbed dose determination layer, it can prevent components contained in a composition for determination of ionizing radiation absorbed dose from migrating inside a bag. In addition, the foregoing ultraviolet shielding layer can be provided.

In this way, a sheet for determination of ionizing radiation absorbed dose and a container for determination of ionizing radiation absorbed dose obtained by printing and coating the composition for determination of ionizing radiation absorbed dose of the present invention are also included in the scope of the present invention.

### EXAMPLES

The present invention will be described in detail with reference to Examples below, but the present invention is not limited to these Examples. Additionally, unless otherwise noted, “%” means “% by mass”, “part” means “part by mass.” An average particle diameter of zinc oxide was measure by a micro track particle diameter measuring apparatus (UPA-150, 9230-UPA, manufactured by LEED & NOR THRUP COMPANY).

### Example 1

Into 75 parts by mass of xylene, 100 parts by mass of Alcon P-140 (alicyclic hydrocarbon, manufactured by Arakawa Chemical Industries Ltd.) was dissolved, 25 parts by mass of zinc oxide having an average particle diameter of 20 nm was added to the solution, stirred and mixed by a paint conditioner. To the resultant zinc oxide-containing mixture was added a solution of 0.94 parts by mass of leuco crystal violet as color indicative electron-donating organic compound, 0.97 parts by mass of vitamin E as an antioxidant and 22.75 parts by mass of 1,2,3-trichlorobenzene as an organic compound showing an electron-accepting property by ionizing radiation dissolved in 50 parts by mass of xylene, and stirred to produce a composition for determination of ionizing radiation absorbed dose (content of zinc oxide: 16.7% based on the total mount of the composition).

The composition for determination of ionizing radiation absorbed dose was applied to a synthetic paper (YUPO manufactured by Oji Paper Co., Ltd., hereinafter the same) so that a dry membrane thickness became about 20 μm, dried, thereby to give a sheet for determination of ionizing radiation absorbed dose. On the membrane of composition for determination of ionizing radiation absorbed dose of the sheet, a UV shielding film (manufactured by Sakata INX Corporation; coated film applied with XGL-2400 UV shielding medium, hereinafter the same) was stuck, which was subjected to exposure of γ-ray from Co-60 of 500 Gy and 2000 Gy, thereby it was confirmed that visibility was good and coloring occurred in a stepwise increase in concentration. Additionally, all operations from production of the composition for determination of ionizing radiation absorbed dose, production of a sheet for determination of ionizing radiation absorbed dose to adhesion of UV shielding film were done under fluorescence light, but no coloring was observed all that time (the same in Examples 2 to 7, and Comparative example 1).

Further, in order to confirm ultraviolet shielding effect, a UV shielding film adhered on the membrane of the composition for determination of ionizing radiation absorbed dose of the above-described sheet for determination was subjected to an accelerated exposure test and measured for a time until coloring by using a light resistance tester (2.5 kw xenon lamp, manufactured by Atlas Corporation) to find coloring after 6-hour exposure (corresponding to about 14 days in an annual average under normal exposure conditions).

### Example 2

Into 75 parts by mass of xylene, 100 parts by mass of Alcon P-140 was dissolved, 25 parts by mass of zinc oxide having an average particle diameter of 35 nm was added to the solution, stirred and mixed by a paint conditioner. To the resultant zinc oxide-containing mixture was added a solution of 0.94 parts by mass of leuco crystal violet as a color indicative electron-donating organic compound, 0.97 parts by mass of vitamin E as an antioxidant and 22.75 parts by mass of 1,2,3-trichlorobenzene as an organic compound showing an electron-accepting property by ionizing radiation dissolved in 50 parts by mass of xylene, and stirred to produce a composition for determination of ionizing radiation absorbed dose (content of zinc oxide: 16.7% based on the total mount of the composition).

The composition for determination of ionizing radiation absorbed dose was applied to a synthetic paper so that a dry membrane thickness became about 20 μm, dried, thereby to give a sheet for determination of ionizing radiation absorbed dose. On the membrane of composition for determination of ionizing radiation absorbed dose of the sheet, a UV shielding film was stuck, which was subjected to exposure of γ-ray from Co-60 of 500 Gy and 2000 Gy, thereby it was confirmed that visibility was good and coloring occurred in a stepwise increase in concentration.

Further, in order to confirm ultraviolet shielding effect, a UV shielding film adhered on the membrane of the composition for determination of ionizing radiation absorbed dose of the above-described sheet for determination was subjected to an accelerated exposure test and measured for a time until coloring by using a light resistance tester (2.5 kw xenon lamp, manufactured by Atlas Corporation) to find coloring after 6-hour exposure (corresponding to about 14 days in an annual average under normal exposure conditions).

### Example 3

Into 75 parts by mass of xylene, 100 parts by mass of Alcon P-140 was dissolved, 12.5 parts by mass of zinc oxide having an average particle diameter of 20 nm was added to the solution, stirred and mixed by a paint conditioner.

To the resultant zinc oxide-containing mixture was added a solution of 0.94 parts by mass of leuco crystal violet as a color indicative electron-donating organic compound, 0.97 parts by mass of vitamin E as an antioxidant and 22.75 parts by mass of 1,2,3-trichlorobenzene as an organic compound showing an electron-accepting property by ionizing radiation dissolved in 50 parts by mass of xylene, and stirred to produce a composition for determination of ionizing radiation absorbed dose (content of zinc oxide: 9.1% based on the total mount of the composition).

The composition for determination of ionizing radiation absorbed dose was applied to a synthetic paper so that a dry membrane thickness became about 20 μm, dried, thereby to give a sheet for determination of ionizing radiation absorbed dose. On the membrane of composition for determination of ionizing radiation absorbed dose of the sheet, a UV shielding film was stuck, which was subjected to exposure of γ-ray from Co-60 of 600 Gy and 2000 Gy, thereby it was confirmed that visibility was good and coloring occurred in a stepwise increase in concentration.

Further, in order to confirm ultraviolet shielding effect, a UV shielding film adhered on the membrane of the composition for determination of ionizing radiation absorbed dose of the above-described sheet for determination was subjected to an accelerated exposure test and measured for a time until coloring by using a light resistance tester (2.5 kw xenon lamp, manufactured by Atlas Corporation) to find coloring after 6-hour exposure (corresponding to about 14 days in an annual average under normal exposure conditions).

### Example 4

Into 75 parts by mass of xylene, 100 parts by mass of Alcon P-140 was dissolved, 30 parts by mass of zinc oxide having an average particle diameter of 20 nm was added to the solution, stirred and mixed by a paint conditioner. To the resultant zinc oxide-containing mixture was added a solution of 0.94 parts by mass of leuco crystal violet as a color indicative electron-donating organic compound, 0.97 parts by mass of vitamin E as an antioxidant and 22.75 parts by mass of 1,2,3-trichlorobenzene as an organic compound showing an electron-accepting property by ionizing radiation dissolved in 50 parts by mass of xylene, and stirred to produce a composition for determination of ionizing radiation absorbed dose (content of zinc oxide: 21.9% based on the total mount of the composition).

The composition for determination of ionizing radiation absorbed dose was applied to a synthetic paper so that a dry membrane thickness became about 20 μm, dried, thereby to give a sheet for determination of ionizing radiation absorbed dose. On the membrane of composition for determination of ionizing radiation absorbed dose of the sheet, a UV shielding film was stuck, which was subjected to exposure of γ-ray from Co-60 of 600 Gy and 2000 Gy, thereby it was confirmed that visibility was good and coloring occurred in a stepwise increase in concentration.

Further, in order to confirm ultraviolet shielding effect, a UV shielding film adhered on the membrane of the composition for determination of ionizing radiation absorbed dose of the above-described sheet for determination was subjected to an accelerated exposure test and measured for a time until coloring by using a light resistance tester (2.5 kw xenon lamp, manufactured by Atlas Corporation) to find coloring after 6-hour exposure (corresponding to about 14 days in an annual average under normal exposure conditions).

### Example 5

Into 75 parts by mass of xylene, 100 parts by mass of Alcon P-140 was dissolved, 25 parts by mass of zinc oxide having an average particle diameter of 20 nm was added to the solution, stirred and mixed by a paint conditioner. To the resultant zinc oxide-containing mixture was added a solution of 0.94 parts by mass of leuco crystal violet as a color indicative electron-donating organic compound, 0.97 parts by mass of vitamin E as an antioxidant and 10.80 parts by mass of 1,2,3,4-tetrachlorobenzene as an organic compound showing an electron-accepting property by ionizing radiation dissolved in 50 parts by mass of xylene, and stirred to produce a composition for determination of ionizing radiation absorbed dose (content of zinc oxide: 18.2% based on the total mount of the composition).

The composition for determination of ionizing radiation absorbed dose was applied to a synthetic paper so that a dry membrane thickness became about 20 μm, dried, thereby to give a sheet for determination of ionizing radiation absorbed dose. On the membrane of composition for determination of ionizing radiation absorbed dose of the sheet, a UV shielding film was stuck, which was subjected to exposure of γ-ray from Co-60 of 600 Gy and 2000 Gy, thereby it was confirmed that visibility was good and coloring occurred in a stepwise increase in concentration.

Further, in order to confirm ultraviolet shielding effect, a UV shielding film adhered on the membrane of the composition for determination of ionizing radiation absorbed dose of the above-described sheet for determination was subjected to an accelerated exposure test and measured for a time until coloring by using a light resistance tester (2.5 kw xenon lamp, manufactured by Atlas Corporation) to find coloring after 6-hour exposure (corresponding to about 14 days in an annual average under normal exposure conditions).

### Example 6

Into 75 parts by mass of xylene, 100 parts by mass of Alcon P-140 was dissolved, 25 parts by mass of zinc oxide having an average particle diameter of 20 nm was added to the solution, stirred and mixed by a paint conditioner. To the resultant zinc oxide-containing mixture was added a solution of 0.94 parts by mass of leuco crystal violet as a color indicative electron-donating organic compound, 0.97 parts by mass of vitamin E as an antioxidant and 10.80 parts by mass of 1,2,3,4-tetrachlorobenzene as an organic compound showing an electron-accepting property by ionizing radiation dissolved in 50 parts by mass of xylene, and stirred to produce a composition for determination of ionizing radiation absorbed dose (content of zinc oxide: 18.2% based on the total mount of the composition).

The composition for determination of ionizing radiation absorbed dose was applied to a synthetic paper so that a dry membrane thickness became about 20 μm, dried, thereby to give a sheet for determination of ionizing radiation absorbed dose. On the membrane of composition for determination of ionizing radiation absorbed dose of the sheet, a UV shielding film was stuck, which was subjected to exposure of γ-ray from Co-60 of 600 Gy and 2000 Gy, thereby it was confirmed that visibility was good and coloring occurred in a stepwise increase in concentration.

Further, in order to confirm ultraviolet shielding effect, a UV shielding film adhered on the membrane of the composition for determination of ionizing radiation absorbed dose of the above-described sheet for determination was subjected to an accelerated exposure test and measured for a time until coloring by using a light resistance tester (2.5 kw xenon lamp, manufactured by Atlas Corporation) to find coloring after 6-hour exposure (corresponding to about 14 days in an annual average under normal exposure conditions).

### Example 7

Into 75 parts by mass of xylene, 100 parts by mass of Alcon P-140 was dissolved, 25 parts by mass of zinc oxide having an average particle diameter of 250 nm was added to the solution, stirred and mixed by a paint conditioner. To the resultant zinc oxide-containing mixture was added a solution of 0.94 parts by mass of leuco crystal violet as a color indicative electron-donating organic compound, 0.97 parts by mass of vitamin E as an antioxidant and 22.75 parts by mass of 1,2,3-trichlorobenzene as an organic compound showing an electron-accepting property by ionizing radiation dissolved in 50 parts by mass of xylene, and stirred to produce a composition for determination of ionizing radiation absorbed dose (content of zinc oxide: 16.7% based on the total mount of the composition).

The composition for determination of ionizing radiation absorbed dose was applied to a synthetic paper so that a dry membrane thickness became about 20 μm, dried, thereby to give a sheet for determination of ionizing radiation absorbed dose. On the membrane of composition for determination of ionizing radiation absorbed dose of the sheet, a UV shielding film was stuck, which was subjected to exposure of γ-ray from Co-60 of 600 Gy and 2000 Gy, thereby it was confirmed that visibility was low, but coloring occurred in a stepwise increase in concentration.

Further, in order to confirm ultraviolet shielding effect, a UV shielding film adhered on the membrane of the composition for determination of ionizing radiation absorbed dose of the above-described sheet for determination was subjected to an accelerated exposure test and measured for a time until coloring by using a light resistance tester (2.5 kw xenon lamp, manufactured by Atlas Corporation) to find coloring after 6-hour exposure (corresponding to about 14 days in an annual average under normal exposure conditions).

### COMPARATIVE EXAMPLE 1

To a solution of 100 parts by mass of Alcon P-140 dissolved in 75 parts by mass of xylene was added a solution of 0.94 parts by mass of leuco crystal violet as a color indicative electron-donating organic compound, 0.97 parts by mass of vitamin E as an antioxidant and 22.75 parts by mass of 1,2,3-trichlorobenzene as an organic compound showing an electron-accepting property by ionizing radiation dissolved in 50 parts by mass of xylene, and stirred to produce a composition for determination of ionizing radiation absorbed dose.

The composition for determination of ionizing radiation absorbed dose was applied to a synthetic paper so that a dry membrane thickness became about 20 μm, dried, thereby to give a sheet for determination of ionizing radiation absorbed dose. On the membrane of composition for determination of ionizing radiation absorbed dose of the sheet, a UV shielding film was stuck, which was subjected to exposure of γ-ray from Co-60 of 600 Gy and 2000 Gy, thereby it was confirmed that visibility was good and coloring occurred in a stepwise increase in concentration.

Further, in order to confirm ultraviolet shielding effect, a UV shielding film adhered on the membrane of the composition for determination of ionizing radiation absorbed dose of the above-described sheet for determination was subjected to an accelerated exposure test and measured for a time until coloring by using a light resistance tester (2.5 kw xenon lamp, manufactured by Atlas Corporation) to find coloring after 3 hour exposure (corresponding to about 7 days in an annual average under normal exposure conditions).

Test examples (light resistance test of composition for determination of ionizing radiation absorbed dose)

The compositions for determination of ionizing radiation absorbed dose in Example 1 and Comparative example 1 were each placed in a sample bottle, an accelerated exposure test was done and a time until coloring was measured using a light resistance tester (2.5 kw xenon lamp, manufactured by Atlas Corporation).

As a result, in the case of the composition for determination of ionizing radiation absorbed dose in Example 1, no coloring was observed even after 1-hour exposure (corresponding to 2.3 days in an annual average), whereas in the case of the composition for determination of ionizing radiation absorbed dose in Comparative example 1, coloring occurred after 1 minute exposure (corresponding to about 1 hour in an annual average).

### INDUSTRIAL APPLICABILITY

In the present invention, to simplify the production of a composition for determination, by just directly mixing zinc oxide with a material capable of coloring or discoloring even by low absorbed dose of ionizing radiation, it is possible to obtain a composition for determination capable of avoiding influences of visible lights and ultraviolet rays.

Further, visibility of coloring and discoloring of a material capable of coloring or discoloring by ionizing radiation is not disturbed by specifying an average particle diameter of zinc oxide used preferably in at most 0.2 μm.

1. A composition for determination of ionizing radiation absorbed dose comprising a material capable of coloring or discoloring by ionizing radiation, which further comprises zinc oxide.

2. The composition for determination of ionizing radiation absorbed dose of claim 1, wherein said zinc oxide has an average particle diameter of at most 0.2 μm.

3. The composition for determination of ionizing radiation absorbed dose of claim 2, wherein the material capable of coloring or discoloring by ionizing radiation contains at least one member selected from the group consisting of (A) combination of a color indicative electron-donating organic compound and an organic compound showing an electron-accepting property by ionizing radiation, and (B) at least one dye selected from the group consisting of dyes capable of coloring through decomposition upon exposure to ionizing radiation.

4. The composition for determination of ionizing radiation absorbed dose of claim 3, wherein the content of said zinc oxide is 1 to 50% by mass based on the total amount of the composition for determination of ionizing radiation absorbed dose.

5. A sheet for determination of ionizing radiation absorbed dose, wherein a layer formed from the composition for determination of ionizing radiation absorbed dose of claim 1 is formed on at least a part of a substrate.

6. The sheet for determination of ionizing radiation absorbed dose of claim 5, wherein at least one other layer is formed between a substrate and a layer formed from the composition for determination of ionizing radiation absorbed dose.

7. The sheet for determination of ionizing radiation absorbed dose of claim 5, wherein at least one other layer is formed on the surface of said layer formed from the composition for determination of ionizing radiation absorbed dose at an opposite side to the substrate.

8. The sheet for determination of ionizing radiation absorbed dose of claim 5, wherein at least one layer present on one side or both sides of said layer formed from the composition for determination of ionizing radiation absorbed dose has a gas barrier function.

9. A container for determination of ionizing radiation absorbed dose, where a layer formed from the composition for determination of ionizing radiation absorbed dose of claim 1 is formed at least partly.

10. The container for determination of ionizing radiation absorbed dose of claim 9, wherein at least a part of the container has a region laminated with at least 3 layers, and said layer formed from the composition for determination of ionizing radiation absorbed dose constitutes an intermediate layer of said region.

11. The container for determination of ionizing radiation absorbed dose of claim 10, wherein at least one layer of at least one side layer sandwiching the layer formed from the composition for determination of ionizing radiation absorbed dose has a gas barrier function.

12. The composition for determination of ionizing radiation absorbed dose of claim 1, wherein the material capable of coloring or discoloring by ionizing radiation contains at least one member selected from the group consisting of (A) combination of a color indicative electron-donating organic compound and an organic compound showing an electron-accepting property by ionizing radiation, and (B) at least one dye selected from the group consisting of dyes capable of coloring through decomposition upon exposure to ionizing radiation.

13. The composition for determination of ionizing radiation absorbed dose of claim 1, wherein the content of said zinc oxide is 1 to 50% by mass based on the total amount of the composition for determination of ionizing radiation absorbed dose.

14. The composition for determination of ionizing radiation absorbed dose of claim 2, wherein the content of said zinc oxide is 1 to 50% by mass based on the total amount of the composition for determination of ionizing radiation absorbed dose.
